(19) United States
(12) Patent Application Publication
(10) Pub. No.: US 2004/0088203 A1
(43) Pub. Date: May 6, 2004

(54) Insured warranty system and method

(75) Inventors: Hideyuki Kakuwa, Tokyo (JP); Tatsuya Ogishi, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignees: HIDEYUKI KAKUWA, Tokyo (JP); HIKARI HOSHO CO., LTD., Tokyo (JP)

(21) Appl. No.: 10/692,858

(22) Filed: Oct. 27, 2003

(30) Foreign Application Priority Data
Oct. 29, 2002 (JP) 2002-314951

(51) Int. Cl. G06F 17/60

(52) U.S. Cl. 705/4

(57) ABSTRACT

An insured warranty system 2 for performing processing by using a computer, wherein a part or all of insurance premiums paid to a guaranty company 6 by a client 3 who got a loan from a financial company 4 is paid to a nonlife insurance company 8 as insurance money by said guaranty company 6; when said client 3 becomes unable to work for more than one month and not more than seven months, a monthly repayment amount by the client 3 to the financial company 4 during the period of being unable to work is paid by said nonlife insurance company 8 as insurance money in accordance with a period obtained by subtracting one month of an exceptional period from the actual period of being unable to work; when said client 3 is unable to work for more than seven months, said guaranty company 6 pays as guarantee a remaining repayment amount until the end of the period of being unable to work after exceeding the seven months, besides payments by said nonlife insurance institution 8. According to the invention, a consumer (client) can borrow money with a sense of security and obtain full security, and a financial institution can save expenses on collecting operations and prevent loans from becoming nonperforming.

### BACKGROUND OF THE INVENTION

1. Field of the Invention

The present invention relates to an insured warranty system and a method, by which a client can borrow money with a sense of security and enjoy full warranty which was conventionally unavailable, while a financial institution can save costs on collection operations and avert loans to become nonperforming (to become bad loans).

2. Description of the Related Art

The Japanese economy has continued to expand by virtue of borrowing low-interest capitals from financial institutions. However, due to the collapse of economic bubbles in recent years, banks, consumer credits and other financial institutions are unable to solve a significant problem of the write-off of bad loans and tend to become reluctant to lend money to clients, such as individuals and companies (a credit crunch). Consequently, the unemployment rate exceeded 5% of the employment population and the number of jobless workers exceeded three millions in recent years. When collection of bad loans is forced through under such circumstance, there are threats of a further increase of the number of bankrupted companies and an increase of the number of individuals to be fired and unemployed because of restructuring.

Under the circumstances, encouragement of borrowing funds from financial institutions is desired in order to prevent companies from going bankrupt and prevent individuals from being fired.

Conventionally, when a consumer (client) gets a loan from a financial institution, the consumer himself/herself takes out an insurance policy by paying insurance premiums or asks a guaranty institution for guaranty by paying guarantee charges. Alternately, the financial institution gets the consumer covered by damage insurance by paying insurance premiums without an application by the consumer himself/herself.

However, even if being covered by a life insurance, nothing is secured in the case of becoming unable to work for a certain period, for example, due to a traffic accident or unemployment. On the other hand, when covered by damage insurance, the insurance can be obtained to a certain extent in the case of becoming unable to work due to this kind of reason, however, in the case hospital stay by a traffic accident or unemployment becomes long, it became no longer possible to cover by the insurance in many cases.

Also, conventional guarantee by guaranty companies have short guarantee period, so that the consumers cannot be fully secured.

Furthermore, in the case of voluntary bankruptcy, nothing is secured.

### SUMMARY OF THE INVENTION

An object of the present invention is to provide an insured warranty system and a method, by which a consumer (client) can borrow money with a sense of security and enjoy full warranty, and a financial institution can save costs on a collection operation and avert loans to become nonperforming (to become bad loans).

(1) To attain the above object, according to a first aspect of the present invention, there is provided an insured warranty system for performing processing by using a computer, wherein a part or all of insurance premiums paid to a guaranty institution by a client who got a loan from a financial institution is paid to a nonlife insurance institution by said guaranty institution as insurance money; when said client becomes unable to work during a first period, a monthly repayment amount by the client to the financial institution during the period of being unable to work is paid by said nonlife insurance institution as insurance money in accordance with a period obtained by subtracting an exceptional period from the actual period of being unable to work; and when said client are unable to work for more than upper limit months of said first period, said guaranty institution pays as guarantee a remaining repayment amount until the end of the period of being unable to work after exceeding the upper limit months of said first period, besides said payments by the nonlife insurance institution.

According to a second aspect of the present invention, there is provided an insured warranty system for performing processing by using a computer, wherein a part or all of mutual aid premiums paid to a mutual aid institution by a client who got a loan from a financial institution is paid to a guaranty institution as guarantee and to a nonlife insurance institution as insurance money by said mutual aid institution; when said client becomes unable to work during a first period, a monthly repayment amount by the client to the financial institution during the period of being unable to work is paid by said nonlife insurance institution as insurance money in accordance with a period obtained by subtracting an exceptional period from the actual period of being unable to work; and when said client is unable to work for more than upper limit months of said first period, said guaranty institution pays as guarantee a remaining repayment amount until the end of the period of being unable to work after exceeding the upper limit months of said first period, besides said payments by the nonlife insurance institution.

According to a third aspect of the present invention, there is provided an insured warranty system for performing processing by using a computer, wherein a part or all of mutual aid premiums paid to a mutual aid institution by a client who got a loan from a financial institution is paid to an insurance institution by said mutual aid institution; and during a first period, when said client (i) goes into voluntary bankruptcy, a remaining principal amount by the client to the financial institution after that is paid by said insurance institution in a range of up to a limit amount set in advance (that is, a limit amount of security. It will be the same below.); (ii) dies, and when the limit amount is not more than a remaining principal amount as a result of comparing the remaining principal amount by the client to the financial institution with the limit amount set in advance, the limit amount is paid by said insurance institution, while when the limit amount exceeds the remaining principal amount, the limit amount and a balance obtained by subtracting the remaining principal amount from the limit amount are paid by said insurance institution; and (iii) gets hospitalized or encounters a disaster on house, an amount of one month of monthly repayment by the client to the financial institution is paid by said insurance institution.

In the third aspect, the number of the insurance institutions to which the mutual aid institution pays a part or all of the mutual aid premiums, and it may be one institution or two or more institutions. In the invention according to the third aspect, a fourth aspect below is preferable.

According to a fourth aspect of the present invention, insured warranty system for performing processing by using a computer, wherein a part or all of mutual aid premiums paid to a mutual aid institution by a client who got a loan from a financial institution is paid to two nonlife insurance institutions and one life insurance institution by said mutual aid institution; and during a first period, when said client (i) goes into voluntary bankruptcy, a remaining principal amount by the client to the financial institution after that is paid by one or both of said two nonlife insurance institutions in a range of up to a amount set in advance; (ii-1) dies of injury, and when the limit amount is not more than a remaining principal amount as a result of comparing the remaining principal amount by the client to the financial institution with the limit amount set in advance, the limit amount is paid by one or both of said two nonlife insurance institutions, while when the limit amount exceeds the remaining principal amount, the limit amount and a balance obtained by subtracting the remaining principal amount from the limit amount are paid by one or both of said two nonlife insurance institutions; (ii-2) dies of sickness, and when the limit amount is not more than a remaining principal amount as a result of comparing the remaining principal amount by the client to the financial institution with the limit amount set in advance, the limit amount is paid by said life insurance institutions, while when the limit amount exceeds the remaining principal amount, the limit amount and a balance obtained by subtracting the remaining principal amount from the limit amount are paid by said life insurance institutions; and (iii) gets hospitalized or encounters a disaster on house, an amount of one month of monthly repayment by the client to the financial institution is paid by one or both of said two nonlife insurance institutions.

(2) To attain the above object, according to the first aspect of the present invention, there is provided aninsured warranty method for performing processing by using a computer, including the step that a part or all of insurance premiums paid to a guaranty institution by a client who got a loan from a financial institution is paid to a nonlife insurance institution by said guaranty institution as insurance money; and the step that when said client becomes unable to work during a first period, a monthly repayment amount by the client to the financial institution during the period of being unable to work is paid by said nonlife insurance institution as insurance money in accordance with a period obtained by subtracting an exceptional period from the actual period of being unable to work; and when said client is unable to work for more than upper limit months of said first period, said guaranty institution pays as guarantee a remaining repayment amount until the end of the period of being unable to work after exceeding the upper limit months of said first period, besides said payments by the nonlife insurance institution.

According to the second aspect of the present invention, there is provided an insured warranty method for performing processing by using a computer, including the step that a part or all of mutual aid premiums paid to a mutual aid institution by a client who got a loan from a financial institution is paid to a guaranty institution as guarantee and to a nonlife insurance institution as insurance money by said mutual aid institution; and the step that when said client becomes unable to work during a first period, a monthly repayment amount by the client to the financial institution during the period of being unable to work is paid by said nonlife insurance institution as insurance money in accordance with a period obtained by subtracting an exceptional period from the actual period of being unable to work; and when said client is unable to work for more than upper limit months of said first period, said guaranty institution pays as guarantee a remaining repayment amount until the end of the period of being unable to work after exceeding the upper limit months of said first period, besides said payments by the nonlife insurance institution.

According to the third aspect of the present invention, there is provided an insured warranty method for performing processing by using a computer, including: the step that a part or all of mutual aid premiums paid to a mutual aid institution by a client who got a loan from a financial institution is paid to an insurance institution by said mutual aid institution; and the step that, during a first period, when said client (i) goes into voluntary bankruptcy, a remaining principal amount by the client to the financial institution after that is paid by said insurance institution in a range up to a limit amount set in advance; (ii) dies, and when the limit amount is not more than a remaining principal amount as a result of comparing the remaining principal amount by the client to the financial institution with the limit amount set in advance, the limit amount is paid by said insurance institution, while when the limit amount exceeds the remaining principal amount, the limit amount and a balance obtained by subtracting the remaining principal amount from the limit amount are paid by said insurance institution; and (iii) gets hospitalized or encounters a disaster on house, an amount of one month of monthly repayment by the client to the financial institution is paid by said insurance institution.

In the invention according to the third aspect, the invention of a fourth aspect described below is preferable.

According to a fourth aspect of the present invention, there is provided an insured warranty method for performing processing by using a computer, including: the step that a part or all of mutual aid premiums paid to a mutual aid institution by a client who got a loan from a financial institution is paid to two nonlife insurance institutions and one life insurance institution by said mutual aid institution; and the step that, during a first period, when said client (i) goes into voluntary bankruptcy, a remaining principal amount by the client to the financial institution after that is paid by one or both of said two nonlife insurance institutions in a range of up to an amount set in advance; (ii-1) die of injury, and when the limit amount is not more than a remaining principal amount as a result of comparing the remaining principal amount by the client to the financial institution with the limit amount set in advance, the limit amount is paid by said one or both of said two nonlife insurance institutions, while when the limit amount exceeds the remaining principal amount, the limit amount and a balance obtained by subtracting the remaining principal amount from the limit amount are paid by one or both of said two nonlife insurance institutions; (ii-2) die of sickness, and when the limit amount is not more than a remaining principal amount as a result of comparing the remaining principal amount by the client to the financial institution with the limit amount set in advance, the limit amount is paid by said life insurance institutions, while when the limit amount exceeds the remaining principal amount, the limit amount and a balance obtained by subtracting the remaining principal amount from the limit amount are paid by said life insurance institutions; and (iii) gets hospitalized or encounters a disaster on house, an amount of one month of monthly repayment by the client to the financial institution is paid by said one or both of said two nonlife insurance institutions.

(3) In the present invention, “becoming unable to work” includes the case that a person having a regular job (a business person) looses the job, the case that a person not having a regular job but having a place of work to go to (a self-employed person, a part-time jobber, a person having a side job (a housewife, a student), etc.) looses the place of work, and the case that a person having a regular job or a person not having a regular job but having a place of work to go to becomes unable to work by being hospitalized due to a sick or injury, etc.

In the present invention, “going into voluntary bankruptcy” means a client who is in multiple debts and unable to repay files a petition of bankruptcy himself/herself and is declared bankrupt. It does not matter whether he or she applies for discharge of bankruptcy to be discharged (write off the debts) after the declaration. Cause of “death” includes being injured by an outsider and becoming sick, etc. Cause of “being hospitalized” includes being injured by an outsider, etc. “a disaster on house” means the case that a client's residence is completely destroyed, partially destroyed due to fire, windstorm or flood or damaged by being flooded above floor level.

In the present invention, “accident” includes physical injuries, such as normal wounds, moreover, physical injuries and mental damages caused by a perpetrator, for example, a stalking behavior.

(4) In the present invention, in the unemployment security applied to the case where a person having a regular job or a place of work to go to looses he job or the place of work (preferably, the case a person having a regular job looses the job), the above first period is not particularly limited, but is preferably more than one month and not more than seven months after payment of guarantee charges or mutual aid premiums is made by the client. Also, an upper limit of an amount to be paid as insurance money by the nonlife insurance institution is not particularly limited, but is preferably an amount of six months of monthly repayments by the client to the financial institution.

In the present invention, an income security applicable to the case where a person who closed a financing agreement with a financial institution, that is, a person to be guaranteed (having a regular job or a place of work to go to) by the guaranty institution gets hospitalized due to sickness or injury and becomes unable to work, the first period is not particularly limited but is preferably more than 7 days and not more than 372 (12 months plus 7 days) after payment of the guarantee charges or mutual aid premiums is made by the client. In this case, the exceptional period is preferably 7 days. Also, the upper limit amount to be paid as insurance money by the nonlife insurance institution is preferably an amount of 12 months of the monthly repayments by the client to the financial institution.

(5) In the present invention, in (i) the voluntary bankruptcy security applicable to the case of voluntary bankruptcy, (ii) the accident and death security applicable to the case of for example death of injury, (iii) the sickness and death security applicable to the case of for example death of sickness, (iv) the accident and hospitalization security applicable to the case of for example being hospitalized by an accident, (v) the stalker and other hospitalization security applicable to the case of for example being hospitalized by an accident, such as stalking, and (vi) the house disaster security applicable to the case of encountering a disaster on house, the first period is not particularly limited, but is preferably a period up to 12 months after payment of mutual aid premiums is made by the client. In this case, the exceptional period in the case that the client goes into voluntary bankruptcy is not particularly limited but is preferably 45 days, and the exceptional period in the case that the client dies, gets hospitalized or encounters a disaster on house is preferably zero.

(6) In the invention according to the first and second aspects, the guaranty institution and the nonlife insurance institution may be configured as one institution. Also, the guaranty institution and the nonlife insurance institution may by made up with a plurality of institutions, such as subsidiary guaranty institutions and subsidiary nonlife insurance institutions, sub- subsidiary guaranty institutions and sub-subsidiary nonlife insurance institutions.

In the invention according to the third aspect, the insurance institution may be configured by a plurality of insurance institutions. In the invention according to the third aspect, “the insurance institution” includes life insurance institutions other than nonlife insurance institutions, which may be domestic and overseas institutions. An insurance institution composed of two nonlife insurance institutions and one life insurance institution is the invention of the fourth aspect. In the invention according to the third and fourth aspects, an insurance institution may include subsidiary insurance institutions and sub-subsidiary insurance institutions, etc.

In the present invention, a “client” includes companies and corporations other than normal individuals. A “financial institution” includes banks, consumer credits and credit loan companies, etc.

### OPERATION AND EFFECT OF THE INVENTION

According to an insured warranty method using an insured warranty system according to the present invention, advantages below are brought to clients. Borrowing with a sense of security becomes possible. Borrowing becomes easier without credit crunch. A mortgage and guarantor are unnecessary, so that there is no need to trouble other person, and there is no needless anxiety and hassle. There is no collection by a financial institution or a debt collection company. Warranty continues until complete payment in some cases. Borrowing with a sense of security becomes possible, and it becomes secured against a contingency. Fringe benefits other than warranty and insurance for members can be promoted by using a mutual aid institution.

Financial institutions can obtain advantages below. Expenses on collection operations can be reduced, it is possible to prevent loans from becoming nonperforming, investment and fundraising can be facilitated, and a healthy composition of finances can be attained. When borrowing by financial institutions is revitalized, a purchasing power of consumers (including clients) improves and the economy is stimulated.

Namely, according to the present invention, consumers (clients) can borrow with a sense of security and receive full insurance, while financial institutions can reduce expenses on collection operations and prevent loans from becoming nonperforming (becoming bad loans).

An insured warranty system and the method of the present invention can be applied to a variety of loans for specific purposes, such as housing loans, and personal free loans other than just fundraising of individuals and companies, etc.

### BRIEF DESCRIPTION OF DRAWINGS

FIG. 1 is a view of the overall configuration of an insured warranty system according to an embodiment of the present invention;

FIG. 2 is a flowchart for explaining an example of an insured warranty method using the system shown in FIG. 1;

FIG. 3 is a block diagram of an example of an insured warranty method using the system shown in FIG. 1;

FIG. 4 is a view of the overall configuration of an insured warranty system according to another embodiment of the present invention;

FIG. 5 is a flowchart for explaining an example of an insured warranty method using the system shown in FIG. 4;

FIG. 6 is a block diagram of an example of an insured warranty method using the system shown in FIG. 4;

FIG. 7 is a view of the overall configuration of an insured warranty system according to another embodiment of the present invention;

FIG. 8 is a flowchart for explaining an example of an insured warranty method using the system shown in FIG. 7; and

FIG. 9 is a block diagram of an example of an insured warranty method using the system shown in FIG. 7.

Here,

2, 2a, 2b . . . insured warranty system

3 . . . client

4 . . . financial company (financial institution)

5 . . . mutual aid institution

6 . . . guaranty company (guaranty institution)

8 . . . nonlife insurance company (insurance institution)

8a . . . first nonlife insurance company (insurance institution)

8b . . . second nonlife insurance company (insurance institution)

9 . . . life insurance company (insurance institution)

40 . . . financial company side terminal

50 . . . mutual aid institution side terminal

60 . . . guaranty company side terminal

80 . . . nonlife insurance company side terminal

81 . . . first nonlife insurance company side terminal

82 . . . second nonlife insurance company side terminal

90 . . . life insurance company side terminal

N1 . . . communication network 40a, 50a, 60a, 80a, 81a, 82a, 90a . . . communication interface 40b, 50b, 60b, 80b, 81b, 82b, 90b . . . computer 40c, 50c, 60c, 80c, 81c, 82c, 90c . . . memory 40d, 50d, 60d, 80d, 81d, 82d, 90d . . . printer.

### DESCRIPTION OF THE PREFERRED EMBODIMENT

Below, the present invention will be explained based on embodiments shown in drawings.

First Embodiment

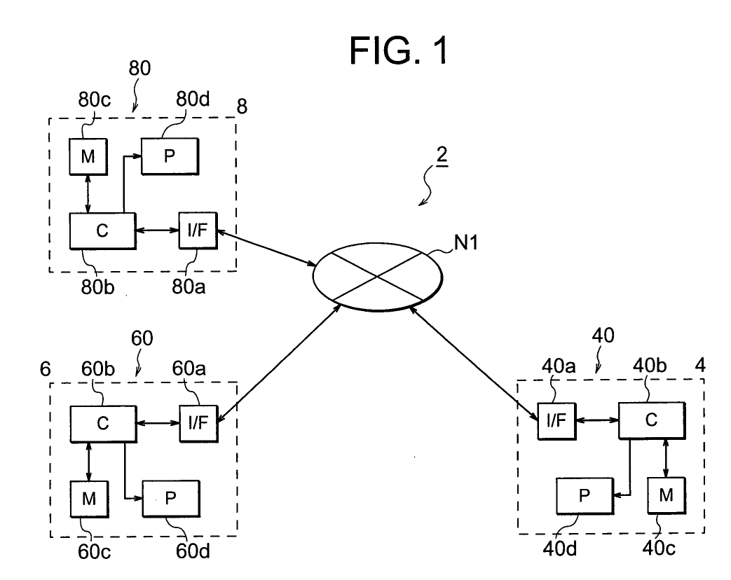

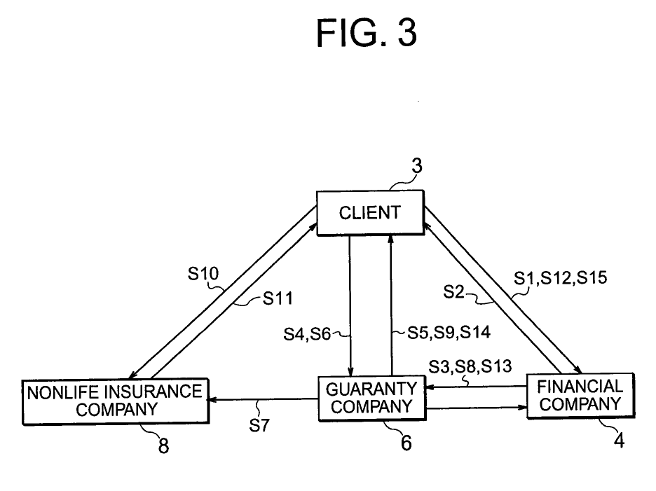

In the present embodiment, an insured warranty method using an insured warranty system 2 shown in FIG. 1 and FIG. 3 will be explained as an example.

The overall configuration of an insured warranty system 2 will be explained first.

In the present embodiment, the case where a guaranty institution and a nonlife insurance institution are made up by separate institutions and each of the institutions does not have any subsidiary institutions nor sub-subsidiary institutions, and that the case of unemployment security to be applied when a person having a regular job (business person) looses the job will be explained.

As shown in FIG. 1 and FIG. 3, the insured warranty system 2 according to the present embodiment is established by a financial company (financial institution) 4 asked to lend money (make a loan) by a client 3, a guaranty company (guaranty institution) 6 and a nonlife insurance company (nonlife insurance institution) 8, by which the client 3 can borrow with a sense of security and receive full security against a contingency.

The insured warranty system 2 comprises a financial company side terminal 40 installed in the financial company, a guaranty company side terminal 60 installed in the guaranty company 6 and a nonlife insurance company side terminal 80 installed in the nonlife insurance company 8, and the respective terminals 40, 60 and 80 are connected to one another to be able to communicate via a communication network N1.

The respective terminals 40, 60 and 80 are provided with communication interfaces (I/F) 40a, 60a and 80a, computers 40b, 60b and 80b, memories 40c, 60c and 80c and printers 40d, 60d and 80d.

The communication I/F 40a, 60a and 80a are for performing interface processing involving information communication via the communication network N1 between an own terminal and other terminals.

The computers 40b, 60b and 80b includes an operation input portion able to be operated by a user for performing processing of receiving information transmitted from other terminals via the respective communication I/F 40a, 60a and 80a and processing of transmitting information to other terminals via the respective communication I/F 40a, 60a and 80a. The computers 40b, 60b and 80b are not limited to a desktop type installed indoor and may be a portable notebook type.

The memories 40c, 60c and 80c are for storing a program and data required by processing in the respective computers 40b, 60b and 80b in advance and storing processing contents and processing results of the respective computers 40b, 60b and 80b (for example, various information T, T1 and invoices) in accordance with need.

The printers 40d, 60d and 80d are for printing and outputting the processing contents and processing results of the respective computers 40b, 60b and 80b in accordance with need.

IDs, passwords and other various information of the respective companies (the respective terminals 40, 60 and 80) are stored in the respective memories 40c, 60c and 80c in the respective terminals 40, 60 and 80, respectively, and the respective computers 40b, 60b and 80b are made to work with the corresponding communication I/F 40a, 60a and 80a.

Note that the configuration shown in FIG. 1 is just to facilitate understanding of the present invention, and a connection form between the respective terminals 40, 60 and 80 and the communication network N1 is not limited to what shown in FIG. 1. Also, a communication means between the respective terminals 40, 60 and 80 is not particularly limited and may be a telephone line, an exclusive line, a radio wave, an optical networking or a combination of them.

Next, an insured warranty method using this insured warranty system 2 will be explained.

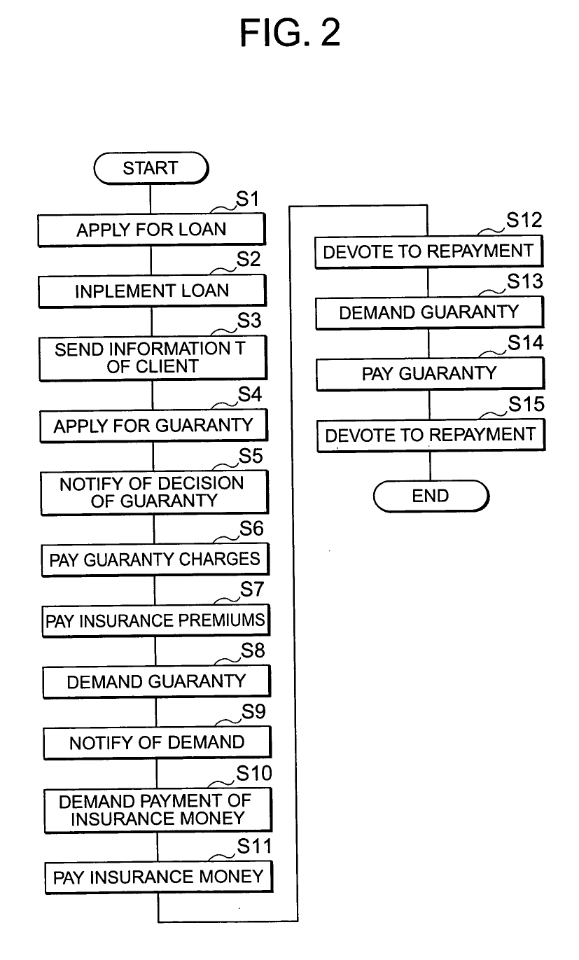

As shown in FIG. 1 to FIG. 3, the client 3 applies for a predetermined amount of loan (borrowing funds) to the financial company 4 first (step S1).

The financial company 4 asked to lend money judges whether it is appropriate to make that amount of loan for the client 3, for example, by using the computer 40b. This judgment may be made by a simple examination to an extent of, for example, whether the amount is appropriate for the annual income of the client 3 or not. Conventionally, the financial company 4 becomes concerned whether or not the client 3 pays back steadily and often becomes reluctant to borrow. However, in the present invention, as will be explained later on, repayment is fully secured by insurance money by the nonlife insurance company 8 and guarantee by the guaranty company 6, so that the financial company 4 can lend a predetermined amount of money to the client 3 with a safe conscience by a relatively simple examination.

Then, when judged that lending is appropriate, the financial company 4 implements the loan to the client 3 (step S2). Implementation of the loan can be made by a bank transfer, etc. At the same time, various information T of the client 3 (for example, name, address, contact information, amount of loan, monthly payment, etc.) is sent to the guaranty company 6, for example, via the computer 40b (step S3).

The client 3 who got the loan from the financial company 4 applies guaranty to the guaranty company 6 (guaranty commission) (step S4). The application of the guaranty may be made, for example, by filling up predetermined items on a predetermined paper given by the guaranty company 6 in advance and filing the same with an identification (for example, a driver's license, a health insurance card, a passport, a certificate of residence, etc.) to the guaranty company 6.

The guaranty company 6 being applied for the guaranty receives the various information T of the client 3, for example, by the computer 60b sent from the financial company 4 via the communication network N1, and when the information T matches with the client 3 who actually filed guaranty commission, it is judged whether a repayment amount by the client 3 to the financial company 4 is appropriate or not. This judgment is made totally by suitably combining a variety of examinations, such as an examination on the workplace (for example, the workplace of the client 3 is listed or not, etc.), an examination on years of employment in the workplace, an examination on years of residence at the current home, an examination on residence classifications (for example, the current home is a home of his/her own or a leased house, etc.), an examination on a health insurance card (a general social insurance or a national health insurance, etc.), an examination on an annual income of the client 3, an examination on the number and amount of loans the client 3 has, and an examination on a marital status, sex, age, family makeup of the client 3, etc. Note that the guaranty limit is not particularly limited but may be, for example, up to 500 thousands yen or 10% or so of the annual income as general rules. As the result, when the guaranty company 6 judges it is appropriate to guarantee the client 3, it decides to guarantee the client 3, and notifies the client 3 of that and to pay a predetermined amount of insurance premium (step S5). The amount of the insurance premium is not particularly limited and may be, for example, 5% or so of the loan amount that the client 3 received from the financial company 4. After that, when the insurance premium is paid by the client 3 to the guaranty company 6, conclusion of the guaranty commission agreement is completed (step S6).

The guaranty company 6 that concluded the guaranty commission contract with the client 3 creates information T1 by performing processing in accordance with need on the various information T of the client 3 sent from the financial company 4, sends the information T1 to the nonlife insurance company 8, for example, via the computer 60b, and pays a part or all (for example, uniformly several thousands yen or so) of insurance premium paid by the client 3 to the nonlife insurance company 8 as insurance premiums (step S7). In the present embodiment, a part or all of the insurance premiums paid by the client 3 to the guaranty company 6 is used for the payment to the nonlife insurance company 8 as insurance premiums in this way. As a result, full guaranty can be obtained even in the case that the client 3 encounters a contingency and becomes unable to pay back thereafter. Payments of the insurance premiums to the nonlife insurance company 8 may be made through a bank transfer or by transfer processing via the computer 60b.

The nonlife insurance company 8 receives, for example, by the computer 80b the information T1 of the client 3 sent from the guaranty company 6 via the communication network N1 and confirms reception of the insurance premiums from the guaranty company 6, for example, by the computer 80b. In the present embodiment, since an all-inclusive contract is concluded between the guaranty company 6 and the nonlife guaranty company 8, conclusion of the insurance commission contract for the client 3 is completed at the time the insurance premium is paid by the guaranty company to the nonlife insurance company 8.

In the case the client 3 becomes unable to work and unable to pay back during the time after one month but not more than 7 months from the payment of the insurance premium by the client 3 (the first period), the financial company 4 demands to the guaranty company 6 to guarantee the amount of repayment to the financing company 4 by the client 3 (step S8). This demand is made, for example, via the computer 40b.

Note that various reasons (that is, applicable conditions of insurance) may be considered for the fact that the client 3 becomes unable to work during the time after one month but not more than 7 months from payment of the insurance premium by the client 3, but when it falls under any of the cases, for example, when the client 3 is unable to work due to involuntary unemployment caused by bankrupt or closedown of a workplace of the client 3 or due to sick or injury for more than two months, etc., it may be treated as what satisfies the applicable condition of the insurance.

The guaranty company 6 receives, for example, by the computer 60b an invoice T2 sent from the financing company 4 via the communication network N1 and notifies the client 3 of that (step S9). Then, the client 3 demands to the nonlife insurance company 8 to pay the insurance money to the client 3 or to the financing company 4 (step S10). The demand by the client 3 to the nonlife insurance company 8 is made, for example, through a telephone line, etc. Note that the guaranty company 6 may demands to the nonlife insurance company 8 to pay the insurance money to the client 3 or to the financing company 4 without notifying the client 3 of that.

The nonlife insurance company 8 that received the demand investigates if necessary or promptly pays a predetermined amount of insurance money to the client 3 or to the financing company 4 (step S11).

The insurance amount to be paid by the nonlife insurance company 8 is the monthly repayment amount (the principal plus interest), but the payment period of the insurance money is six months at most. Namely, when the client 3 becomes unable to work during the time after one month and not more than 7 months from the payment of the insurance premiums by the client 3, the monthly payments that the client 3 has to pay back to the financing company 4 during the period of being unable to work are paid as the insurance money in accordance with the period obtained by subtracting one month of exceptional period from an actual period of being unable to work and up to six months.

When paying the insurance money to the client 3, it may be made, for example, by a bank transfer. When paying to the financing company 4, it may be made also by a bank transfer, etc. or the insurance money may be paid by transfer processing through the computer 80b.

When insurance money is paid from the nonlife insurance company 8 to the client 3, the client 3 can devote the insurance money to the repayment to the financial company 4 (step 12). On the other hand, when the insurance money is paid from the nonlife insurance company 8 to the financial company 4, the financial company 4 confirms the payment, for example, by the computer 40b and deems it as a payment from the client 3.

On the other hand, in the case the client 3 becomes to be unable to work for more than seven months after the payment of the insurance premiums by the client 3 and unable to pay back during that period, the financial company 4 demands to the guaranty company 6 to guarantee the repayment amount by the client 3 to the financial company 4 (step S13). This demand is made, for example, by the computer 40b.

Note that various reasons (that is, applicable conditions of insurance) may be considered for the fact that the client 3 becomes unable to work for more than 7 months from the payment of the insurance premiums by the client 3, but when it falls under any of the cases, for example, when the client 3 is dead, the client 3 is damaged by being used a phony bank account, the client 3 is arrested, the client 3 escapes, an outsider intervenes the client 3, the client 3 is excessively in debt or crushed by debt, and the client 3 defaults, etc., it may be treated as what satisfies the applicable conditions of the insurance.

The guaranty company 6 receives, for example, by the computer 60b an invoice T3 sent from the financial company 4 via the communication network N1 and, after investigation if necessary, or promptly pays as guarantee the remaining repayment amount after seven months until the end of the period of being unable to work to the client 3 or to the financing company 4 for subrogated performance (step S14).

The guarantee paid by the guaranty company 6 is preferably the entire remaining repayment amount (remaining principal plus interest), but it may be a total of the remaining principal and a late payment charge (interest) of a predetermined period (for example, 120 days at most).

When the guarantee is paid to the client 3, it is made, for example, by a transfer to a bank account, etc. When paying to the financial company 4, it may be also made by a bank transfer or the payment of the guarantee to the financial company 4 may be made by transfer processing by the computer 60b.

When the guarantee is paid from the guaranty company 6 to the client 3, the client 3 can devote the guarantee to the repayment to the financial company 4 (step S15). On the other hand, when the guarantee is paid from the guaranty company 6 to the financial company 4, the financial company 4 confirms the payment, for example, by the computer 40b and deems it as a payment from the client 3.

The insured warranty method using the system 2 as above will be furthermore specifically explained. First, the case where Mr. A (the client 3) borrowed 400,000 yen from the financial company 4 by 20 installments of 20,000 yen monthly, encountered a traffic accident after finishing payments for 5 times, got hospitalized for three months, and returned to work will be explained as an example. In this case, one month from the occurrence of the accident is an exceptional period and insurance is not applied by the nonlife insurance company 8. Accordingly, Mr. A can receive payments for the remaining two months as the insurance money from the nonlife insurance company 8 and devote it to the repayment to the financial company 4.

Next, the case where Mr. B (the client 3) borrowed 400,000 yen from the financial company 4 by 20 installments of 20,000 yen monthly, became unemployed after finishing payments for 5 times, and unable to get a job up to now for two years will be explained as an example. In this case, after the one month of exceptional period, Mr. B can receive six months of repayment amount from the nonlife insurance company 8 as the insurance money and, furthermore, the remaining principal in the remaining payment amount and interests up to 120 days from the guarantee company 6 as guarantee. Mr. B can devote the insurance money from the nonlife insurance company 8 and the guarantee from the guaranty company 6 to the repayment to the financial company 4. When assuming that the interest is 1500 yen per month, the guarantee for six months becomes 129,000 yen. The guaranty company 6 pays Mr. B an amount of eight months of remaining principal 160,000 yen and interests 6,000 yen for 120 days. Mr. B pays only the remaining interests of 6,000 for four months.

According to the insured warranty using the system 2 according to the present embodiment, the client 3 obtains advantages below. Borrowing with a sense of security becomes possible. Borrowing becomes easier without credit crunch. A mortgage and guarantor are unnecessary, so that there is no need to trouble other person, and there is no needless anxiety and hassle. The loan is not collected by the financial company 4 or a debt collection company. Warranty continues until complete payment in some cases. Borrowing with a sense of security becomes possible and it becomes secured against a contingency.

Financial company 4 can obtain advantages below. Expenses on collection operations can be reduced, it is possible to prevent loans from becoming nonperforming, investment and fundraising can be facilitated, and a healthy composition of finances can be attained. When lending by financial institutions is revitalized, a purchasing power of consumers (including the client 3) improves and the economy is stimulated.

Second Embodiment

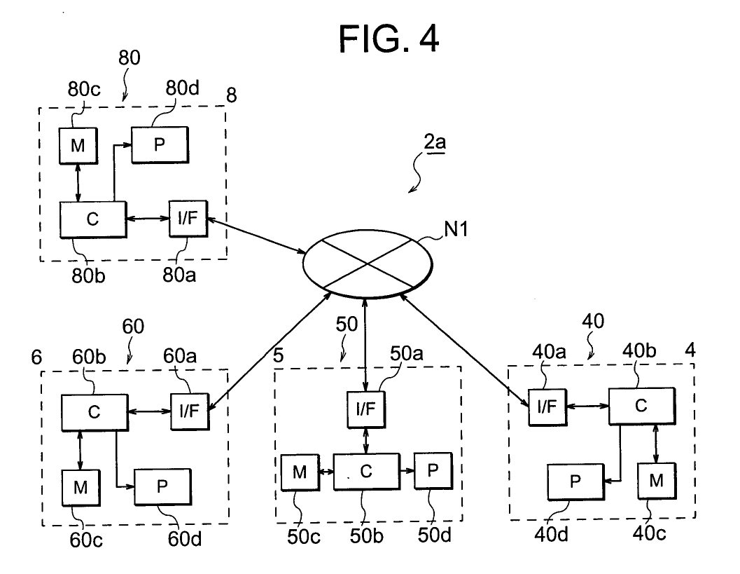

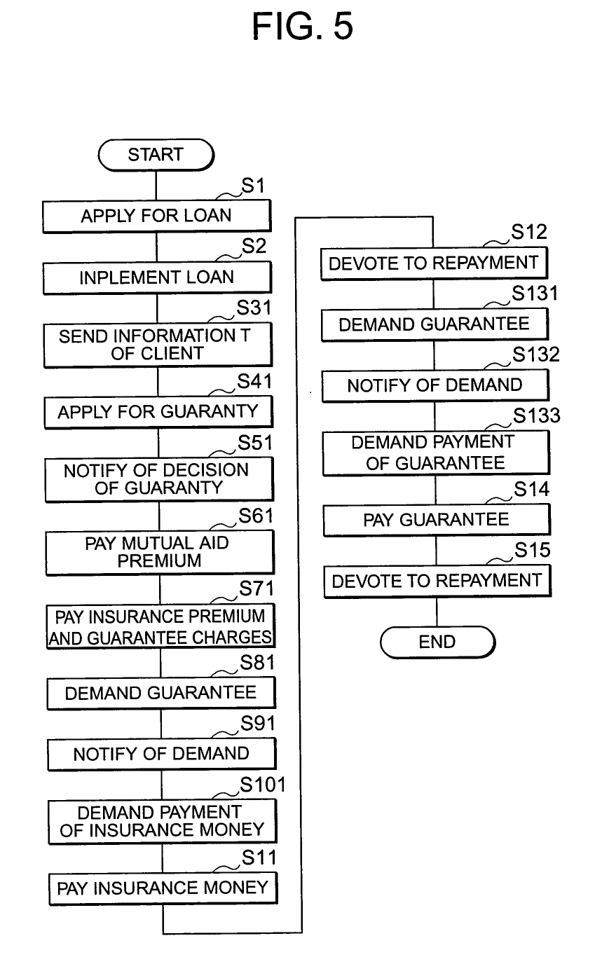

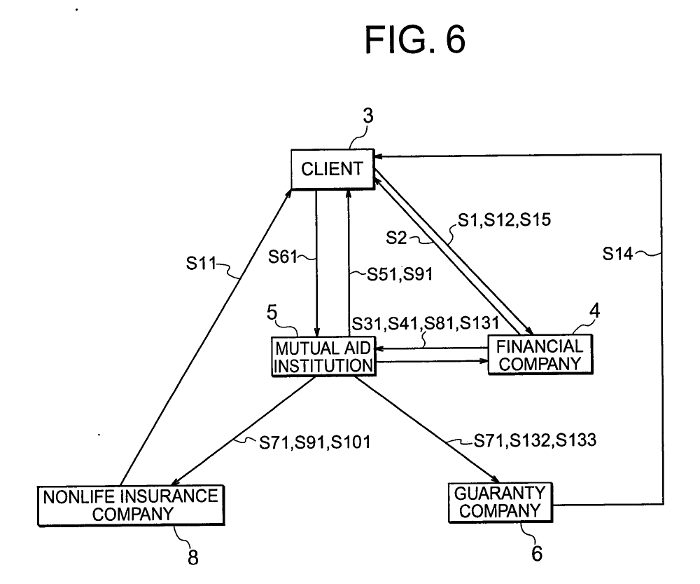

An insured warranty system 2a according to the present embodiment is a modified example of the insured warranty system 2 shown in FIG. 1 to FIG. 3, and different only in the point that a mutual aid institution 5 is provided between the financing company 4 and the guaranty company 6 and the nonlife insurance company 8 as shown in FIG. 4 to FIG. 6. In the explanation below, common portions with those in the first embodiment are given the same reference numbers in the drawings, explanations on the common portions will be omitted, and only different points will be explained in detail.

As shown in FIG. 4 to FIG. 6, the insured warranty system 2a comprises a mutual aid institution side terminal 50 installed in the mutual aid institution 5 other than a financial company side terminal 40, a guaranty company side terminal 60 and a nonlife insurance company side terminal 80, and the respective terminals 40, 50 60 and 80 are connected able to communicate to one another via a communication network N1. The mutual aid institution side terminal 50 comprises a communication interface (I/F) 50a, a computer 50b, a memory 50c and a printer 50d.

Next, an insured warranty method using the insured warranty system 2a will be explained.

As shown in FIG. 4 to FIG. 6, the financial company 4 being applied with a certain amount of loan (make a loan) by the client 3 judges whether it is appropriate to make that amount of loan for the client 3, for example, by using the computer 40b, and when judged that lending is appropriate, the financial company 4 implements the loan to the client 3 (steps S1 and S2). At the same time, various information T of the client 3 is sent to the mutual aid institution 5, for example, via the computer 40b (step S31).

The client 3 who got the loan from the financial company 4 applies guaranty to the mutual aid institution 5 (guaranty commission) (step S41). The application of the guaranty may be made, for example, by filling up predetermined items on a predetermined paper given by the mutual aid institution 5 in advance and filing the same with an identification card to the mutual aid institution 5.

The mutual aid institution 5 being applied for the guaranty receives the various information T of the client 3, for example, by the computer 50b sent from the financial company 4 via the communication network N1, and when the information T matches with the client 3 who actually filed the guaranty commission, it is judged whether a repayment amount by the client 3 to the financial company 4 is appropriate or not.

As the result, when the mutual aid institution 5 judges it is appropriate to guarantee the client 3, it decides to guarantee the client 3 and notifies the client 3 of that and to pay a predetermined amount of mutual aid premiums (step S51). After that, when the mutual aid premium is paid by the client 3 to the mutual aid institution 5, conclusion of the guaranty commission agreement is completed (step S61).

The mutual aid institution 5 that concluded the guaranty commission contract with the client 3 creates information T1 by performing processing in accordance with need on the various information T of the client 3 sent from the financial company 4, sends the information T1 to the guaranty company 6 and the nonlife insurance company 8, for example, via the computer 50b, and pays a part or all of mutual aid premiums paid by the client 3 to the guaranty company 6 as guaranty premiums and to the nonlife insurance company 8 as insurance premiums (step S71). In the present embodiment, a part or the entire mutual aid premium paid by the client 3 to the mutual aid institution 5 is used for the payment to the guaranty company 6 as guaranty premium and to the nonlife insurance company 8 as insurance premium in this way. As a result, full guaranty can be obtained even in the case that the client 3 encounters a contingency and becomes unable to pay back thereafter. Payments of the guaranty premiums to the guaranty company 6 and the insurance premiums to the nonlife insurance company 8 may be made through a bank transfer or by transfer processing via the computer 60b.

The guaranty company 6 receives, for example, by the computer 60b the information T1 of the client 3 sent from the mutual aid institution 5 via the communication network N1 and confirms reception of the guaranty premiums from the mutual aid institution 5, for example, by the computer 60b.

The nonlife insurance company 8 receives, for example, by the computer 80b the information T1 of the client 3 sent from the mutual aid institution 5 via the communication network N1 and confirms reception of the insurance premiums from the mutual aid institution 5, for example, by the computer 80b.

In the case the client 3 becomes unable to work and unable to pay back during the time after one month but not more than 7 months from the payment of the mutual aid premiums by the client 3 (the first period), the financial company 4 demands to the mutual aid institution 5 to guarantee the amount of repayment to the financing company 4 by the client 3 (step S81). This demand is made, for example, via the computer 40b.

The mutual aid institution 5 receives, for example, by the computer 50b an invoice T2 sent from the financial company 4 via the communication network N1, notifies to the nonlife insurance company 8 of that (step S91) and demands to pay the insurance money to the client 3 or the financial company 4 (step S101).

The nonlife insurance company 8 that received the demand investigates in accordance with need or promptly pays a predetermined amount of insurance money to the client 3 or the financial company 4 (step S11).

The insurance amount to be paid by the nonlife insurance company 8 is the monthly repayment amount (the principal plus interest), but the payment period of the insurance money is six months at most. Namely, when the client 3 becomes unable to work during the time after one month but not more than seven months from the payment of the mutual aid premium by the client 3, the monthly repayments that the client 3 has to pay back to the financing company 4 during the period of being unable to work are paid as the insurance money in accordance with a period obtained by subtracting one month of exceptional period from an actual period of being unable to work and up to six months.

When paying the insurance money to the client 3, it may be made, for example, by a bank transfer. When paying to the financing company 4, it may be made by a bank transfer, etc. or the insurance money may be paid by transfer processing through the computer 80b.

When insurance money is paid from the nonlife insurance company 8 to the client 3, the client 3 can devote the insurance money to the repayments to the financial company 4 (step 12). On the other hand, when the insurance money is paid from the nonlife insurance company 8 to the financial company 4, the financial company 4 confirms the payment, for example, by the computer 40b and deems it as a payment from the client 3.

On the other hand, in the case the client 3 becomes to be unable to work for more than seven months after the payment of the mutual aid premiums by the client 3 and unable to pay back during that period, the financial company 4 demands to the mutual aid institution 5 to guarantee the repayment amount by the client 3 to the financial company 4 (step S131). This demand is made, for example, by the computer 40b.

The mutual aid institution 5 receives, for example, by the computer 50b an invoice T3 sent from the financial company 4 via the communication network N1, notifies to the guaranty company 6 of that (step S132), and demands to the guaranty company 6 to pay the remaining repayment amount after seven months until the end of the period of being able to work to the client 3 or to the financial company 4 as the guarantee (step S133).

The guaranty company 6 that received the demand investigates in accordance with need or promptly pays a predetermined amount of guarantee to the client 3 or to the financial company 4 (step S14).

The guarantee amount to be paid by the guaranty company 6 is preferably all of the remaining repayment amount, but it may be a total of the remaining principal and a late payment charge (interest) of a predetermined period (for example, 120 days at most).

When the guarantee is paid to the client 3, it is made, for example, by a transfer to a bank account, etc. When paying to the financial company 4, it may be made by a bank transfer or the payment of the guarantee to the financial company 4 may be also made by transfer processing by the computer 60b.

When the guarantee is paid from the guaranty company 6 to the client 3, the client 3 can devote the guarantee to the repayment to the financial company 4 (step S15). On the other hand, when the guarantee is paid from the guaranty company 6 to the financial company 4, the financial company 4 can confirm the payment, for example, by the computer 40b and deems it as a payment from the client 3.

The same effects as in the above first embodiment can be obtained also by the insured warranty method using the system 2a according to the present embodiment as above, and there are advantages that an increase of bankrupts can be suppressed, and a variety of privileges and services for an object of cultural and economical improvements can be realized as a part of fringe benefits by taking advantage of scale merits of the members based on the mutual aid spirit.

Third Embodiment

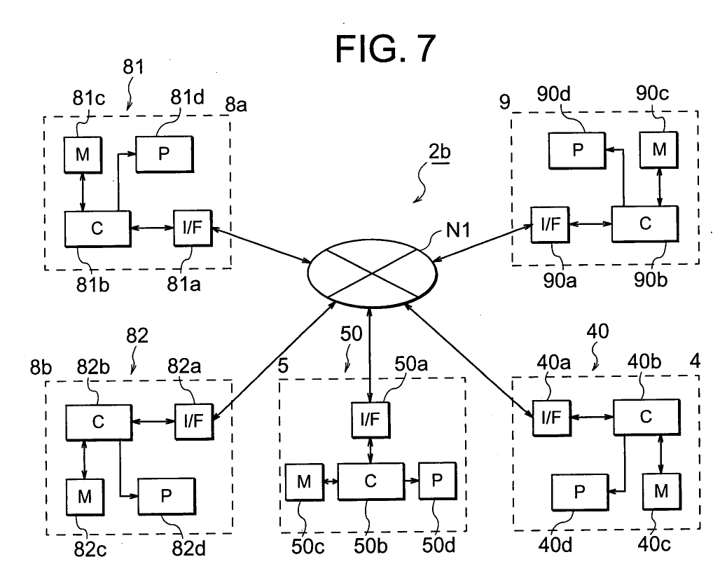

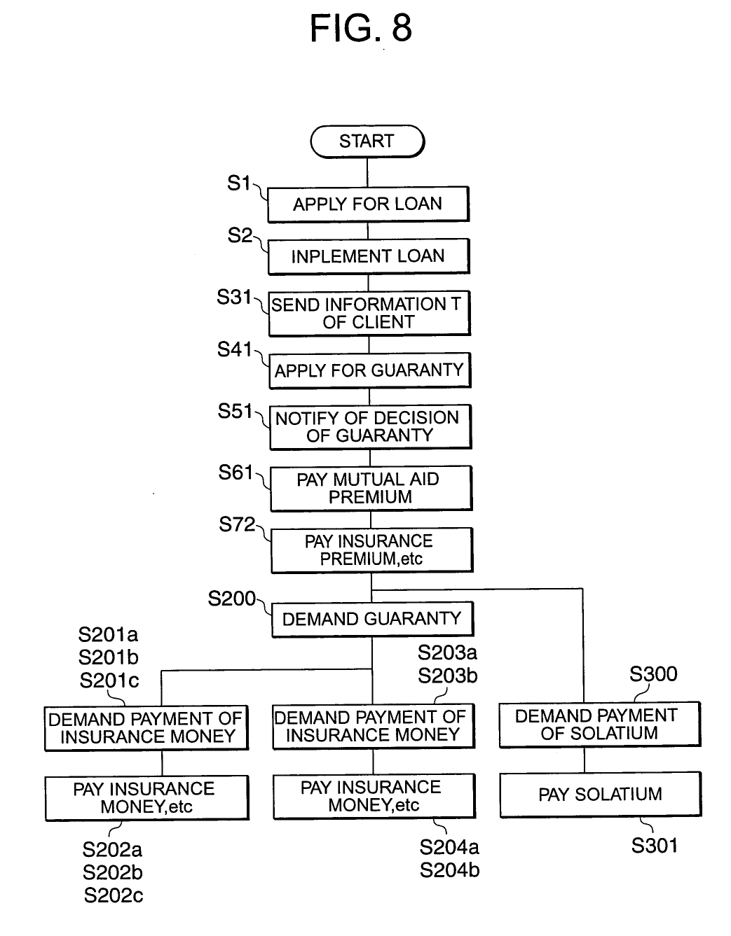

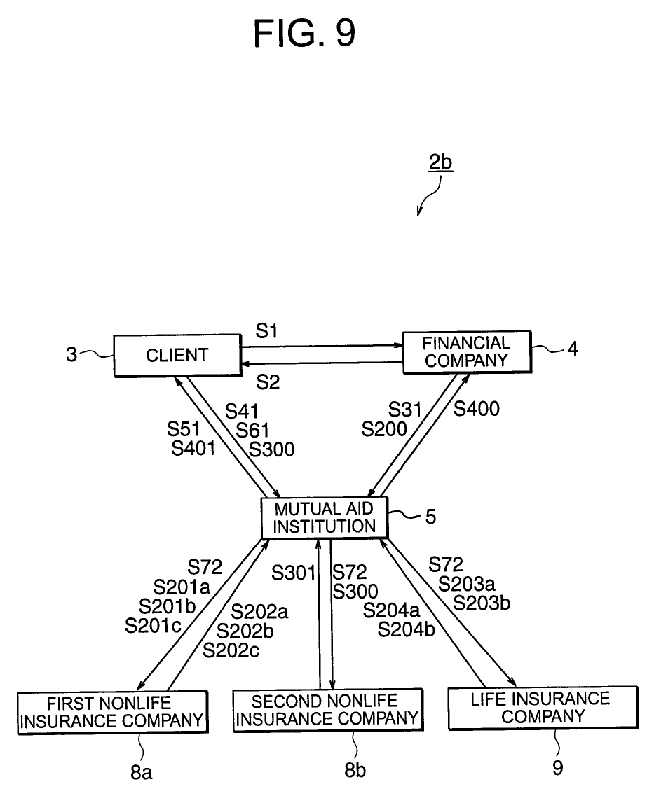

The insured warranty system 2b according to the present embodiment is a modified example of the insured warranty system 2a shown in FIG. 4 to FIG. 6 and is different in the point that the guaranty company 6 is not provided but two nonlife insurance companies 8a and 8b and one life insurance company 9 are provided as shown in FIG. 7 to FIG. 9. In the explanation below, the common portions as those in the first and second embodiments are given the same reference numbers in the drawings, explanations on the common portions will be omitted and only different points will be explained in detail.

As shown in FIG. 7 to FIG. 9, the insured warranty system 2b comprises a first nonlife insurance company side terminal 81 installed in the first nonlife insurance company 8a, a second nonlife insurance side terminal 82 installed in the second nonlife insurance company 8b and a life insurance company side terminal 90 installed in the life insurance company 9 other than a financial company side terminal 40 and a mutual aid institution side terminal 50, and the respective terminals 40, 50, 81, 82 and 90 are connected to be able to communicate to one another via a communication network N1.

The first nonlife insurance company side terminal 81 comprises a communication interface (I/F) 81a, a computer 81b, a memory 81c and a printer 81d. The second nonlife insurance company 82 comprises a communication interface (I/F) 82a, a computer 82b, a memory 82c and a printer 82d. The life insurance company side terminal 90 comprises a communication interface (I/F) 90a, a computer 90b, a memory 90c and a printer 90d.

Next, an insured warranty method using this insured warranty system 2b will be explained.

As shown in FIG. 7 to FIG. 9, the financial company 4 being applied with a certain amount of loan (make a loan) by the client 3 judges whether it is appropriate to make that amount of loan for the client 3, for example, by using the computer 40b, and when judged that lending is appropriate, the financial company 4 implements the loan to the client 3 (steps S1 and S2). At the same time, various information T of the client 3 is sent to the mutual aid institution 5, for example, via the computer 40b (step S31).

The client 3 who got the loan from the financial company 4 applies guaranty to the mutual aid institution 5 (guaranty commission) (step S41). The application of the guaranty may be made, for example, by filling up predetermined items on a predetermined paper given by the mutual aid institution 5 in advance and filing the same with an identification card to the mutual aid institution 5.

The mutual aid institution 5 being applied for the guaranty receives the various information T of the client 3, for example, by the computer 50b sent from the financial company 4 via the communication network N1. Then, whether the received information T matches with the client 3 who actually filed the guaranty commission is judged. When the information T and the client 3 are matched, it is judged whether it is appropriate or not to guarantee the principal of the repayment amount by the client 3 to the financial company 4. When the mutual aid institution 5 judges it is appropriate to guarantee the client 3 as the result, guaranty for the client 3 is decided and notified to the client 3, and the client is notified to pay a predetermined amount of mutual aid premiums (step S51). Then, when the mutual aid premium is paid by the client 3 to the mutual aid institution 5, conclusion of the guarantee commission contract is completed (step S61).

The mutual aid institution 5 that concluded the guaranty commission contract with the client 3 creates information T1 by performing processing in accordance with need on the information T of the client 3 sent from the financial company 4, sends the information T1 to the first nonlife insurance company 8a, second nonlife insurance company 8b and the life insurance company 9, for example, via the computer 50b, and pays a part or all of mutual aid premiums paid by the client 3 to the first nonlife company 8a as insurance premiums, to the second nonlife insurance company 8b as reinsurance premiums, and to the life insurance company 9 as insurance premiums (step S72). In the present embodiment, a part or all of the mutual aid premiums paid by the client 3 to the mutual aid institution 5 is used for the payment to the two nonlife insurance companies 8a and 8b as insurance premiums and reinsurance premiums and to one life insurance company 9 as insurance premiums in this way. As a result, full guaranty can be obtained even in the case that the client 3 goes bankrupt, dies, gets hospitalized, or encounters a disaster on house. Payments of the insurance premium and reinsurance premium to the nonlife insurance companies 8a, 8b and the life insurance company 9 may be made through a bank transfer or by transfer processing via the computer 50b.

The first nonlife insurance company 8a, the second nonlife insurance company 8b and the life insurance company 9 receive, for example, by the computers 81b, 82 and 90b the information T1 of the client 3 sent from the mutual aid institution 5 via the communication network N1 and confirms reception of the insurance premiums and reinsurance premium from the mutual aid institution 5, for example, by the computers 81b, 82b and 90b.

Then, during the first period (the period from the payment of the mutual aid premiums by the client 3 to the mutual aid institution 5 to twelve months in the present embodiment),

when falling into (1) the case the client 3 goes bankrupt or dies by an accident or (2) the case the client 3 dies from sickness, the financial company 4 demands the mutual aid company 5 to guarantee the remaining principal amount in the remaining repayment by the client 3 to the financial company 4 (step S200). This demand is made, for example, through the computer 40b.

The mutual aid company 5 that received the demand receives, for example, by the computer 50b an invoice T2 sent from the financial company 4 via the communication network N1. Then, it is confirmed to make a distinction whether the reason of becoming unable to repay by the client 3 to the financial company 4 is caused by (1-1) voluntary bankruptcy or (1-2) death of injury. When the result is:

The Case of Voluntary Bankruptcy

(1-1) In the case where the reason the client 3 becomes unable to repay to the financial company 4 is caused by voluntary bankruptcy of the client 3, the first nonlife insurance company (an overseas reinsurance company in the present invention) 8a is notified of that and demanded to pay the insurance money for the financial company 4 (step S201a).

The first nonlife insurance company 8a that received the demand investigates in accordance with need or promptly pays a predetermined amount of insurance money for the financial company 4 to the mutual aid institution 5 (step S202a). The insurance amount paid by the first nonlife insurance company 8a in this case is only the remaining principal amount in the remaining repayment amount by the client 3 to the financial company 4 after the voluntary bankruptcy of the client 3. Note that the insurance amount to be paid may be in a range up to a limit amount set in advance. For example, when the remaining principal amount is 200,000 yen and the limit is 300,000 yen, a payment of 200,000 yen is sufficient. When the remaining principal amount is 500,000 and the limit is 300,000, a payment of 300,000 yen is sufficient. Note that calculation of the insurance amount to be paid is assumed to be reckoned from the day after, for example, 45 days of exceptional period after payment of the mutual aid premiums by the client 3 to the mutual aid institution.

The Case of Death of Injury

(1-2) In the case where the reason the client 3 becomes unable to repay to the financial company 4 is caused by death of injury, the mutual aid institution 5 that received the above demand from the financial company 4 compares the remaining principal amount in the remaining repayment amount by the client 3 to the financial company 4 after the death of the client 3 with the limit amount set in advance, and makes a distinction between (1-2-1) the case where the limit amount is not more than the remaining principal amount (limit amount>remaining principal amount) and (1-2-2) the case where the limit amount exceeds the remaining principal amount (limit amount<remaining principal amount).

(1-2-1) In the case that the limit amount is not more than the remaining principal amount (limit amount<remaining principal amount), the mutual aid institution 5 notifies to the first nonlife insurance company 8a and demands to pay the insurance money to the financial company 4 (step S201b).

The first nonlife insurance company 8a that received the demand investigates in accordance with need or promptly pays a predetermined amount of insurance money for the financial company 4 to the mutual aid institution 5 (step S202b). The insurance amount to be paid by the first nonlife insurance company 8a in this case is assumed to be the above limit amount. For example, when the remaining principal amount is 500,000 yen and the limit is 300,000 yen, it is sufficient to pay 300,000 yen. Note that calculation of the insurance amount to be paid is assumed to be reckoned from the day after the payment of the mutual aid premiums by the client 3 to the mutual aid institution (that is, the exceptional period is zero).

(1-2-2) When the limit amount exceeds the remaining principal amount (limit amount>remaining principal amount), the mutual aid institution 5 notifies to the first nonlife insurance company 8a and demands to pay the insurance money for the financial company 4 and solatium for the bereaved of the client 3 (step S201c).

The first nonlife insurance company 8a that received the demand investigates in accordance with need or promptly pays a predetermined insurance money for the financial company 4 and the solatium to the mutual aid institution 5 (step S202c). The insurance amount to be paid by the first nonlife insurance company 8a is the entire remaining principal amount in the remaining repayment amount by the client 3 to the financial company 4 after the death of the client 3. Calculation of the insurance amount to be paid by the first nonlife insurance company 8a is assumed to be reckoned from the day after the payment of the mutual aid premiums by the client 3 to the mutual aid institution (that is, the exceptional period is zero). The amount of the solatium to be paid by the first nonlife insurance company 8a is a balance of the limit amount and the remaining principal amount. For example, when the remaining principal amount is 300,000 yen and the limit amount is 500,000, the first nonlife insurance company 8a pays 300,000 as the insurance money and 200,000 as the solatium.

The Case of Death of Sickness

(2) In the case where the reason the client 3 becomes unable to repay to the financial company 4 is death of sickness of the client 3, the mutual aid institution 5 that received the above demand from the financial company 4 compares the remaining principal amount in the remaining repayment amount by the client 3 to the financial company 4 after the death of the client 3 with the limit amount, and makes a distinction between

(2-1) the case that the limit amount is not more than the remaining principal amount (limit amount<remaining principal amount) and (2-2) the case that the limit amount exceeds the remaining principal amount (limit amount>remaining principal amount).

(2-1) When the limit amount is not more than the remaining principal amount (limit amount<remaining principal amount), the mutual aid institution 5 notifies to the life insurance company (a domestic life insurance company in the present embodiment) 9 and demands to pay the insurance money for the financial company 4 (step S203a).

The life insurance company 9 that received the demand investigates in accordance with need or promptly pays a predetermined amount for the financial company 4 to the mutual aid institution 5 (step S204a). The insurance amount to be paid by the life insurance company 9 is assumed to be the above limit amount. For example, when the remaining principal amount is 500,000 yen and the limit is 300,000 yen, it is sufficient to pay 300,000. Note that calculation of the insurance amount is assumed to be reckoned from the day after the payment of the mutual aid premiums by the client 3 to the mutual aid institution (that is, the exceptional period is zero).

(2-2) When the limit amount exceeds the remaining principal amount (limit amount>remaining principal amount), the mutual aid institution 5 notifies to the life insurance company 9 of that and demands to pay the insurance money for the financial company 4 and the solatium for the bereaved of the client 3 (step S203a).

The life insurance company 9 that received the demand investigates in accordance with need or promptly pays a predetermined amount of insurance money for the financial company 4 and the solatium to the mutual aid institution 5 (step S204b). The insurance amount to be paid by the life insurance company 9 in this case is the entire remaining principal amount in the remaining repayment amount by the client 3 to the financial company 4 after the death of the client 3. Calculation of the insurance amount to be paid by the life insurance company 9 is assumed to be reckoned from the day after the payment of the mutual aid premiums by the client 3 to the mutual aid institution (that is, the exceptional period is zero). The amount of the solatium to be paid by the insurance company 9 is a balance of the limit amount and the remaining principal amount. For example, when the remaining principal amount is 300,000 yen and the limit amount is 500,000 yen, the life insurance company 9 pays 300,000 yen as the insurance money and 200,000 yen as the solatium.

On the other hand, during the above first period,

The Case of Being Hospitalized or Encountering Disaster on House

(3) In the case where the client 3 gets hospitalized or encounters a disaster on house, the client 3 demands solatium to the mutual aid institution 5, and the mutual aid institution 5 that received the demand demands to the second nonlife insurance company 8b to pay the solatium for the client 3 (step S300). The demand is made, for example, by the computer 50b.

The second nonlife insurance company (a domestic nonlife insurance company in the present embodiment) 8b that received the demand investigates in accordance with need or promptly pays the solatium to the mutual aid institution 5 (step S301). The amount of the solatium to be paid by the second nonlife insurance company 8b in this case may be, for example, an amount of one month of monthly repayments by the client 3 to the financial company 4. Note that calculation of the solatium amount to be paid is assumed to be reckoned from the day after the payment of the mutual aid premium by the client 3 to the mutual aid institution (that is, the exceptional period is zero)

The payment of the insurance money and/or the solatium to the mutual aid institution 5 by the first nonlife insurance company 8a, the second nonlife insurance company 8b and the life insurance company 9 may be made by transfer processing via the computers 81b, 82b and 90b or by a banking transfer. Note that payment of the solatium may be directly made to the bereaved of the client 3. Payment of the solatium in this case can be made by a banking transfer.

The mutual aid institution 5 that received the insurance money from the first nonlife insurance company 8a and the life insurance company 9 promptly pays to the financial company 4 (step S400). The payment of the insurance money may be made by transfer processing via the computer 50b or by a banking transfer.

On the other hand, the mutual aid institution 5 that received the solatium from the first nonlife insurance company 8a and the second nonlife insurance company 8b promptly pays to the client 3 or the bereaved of the client 3 (step S401). The payment of the solatium may be made by a banking transfer, etc.

Note that a limit amount of the insurance money to be paid by the first nonlife insurance company 8a and the life insurance company 9 is not particularly limited, and may be determined, for example, in accordance with insurance premium rates. For example, the premium rate may be 12.9% (12,900 yen) when the limit amount is 100,000 yen, the premium rate may be 7.96% (23,900 yen) when the limit amount is 300,000 yen, the premium rate may be 6.98% (34,900 yen) when the limit amount is 500,000 yen, the premium rate may be 6.62% (46,400 yen) when the limit amount is 700,000 yen, and the premium rate may be 6.29% (62,900 yen) when the limit amount is 1000,000 yen.

A further specific example of the insured warranty method using the system 2b as above will be explained.

First, the case where Mr. A (the client 3) borrowed 300,000 yen from the financial company 4 by 15 installments of 20,000 yen monthly and went voluntarily bankrupt after finishing payments for 5 times will be explained as an example. Note that the limit amount is assumed to be 500,000 yen. In this case, since it is after 45 days (an exceptional period) after the payment of the mutual aid premiums, the remaining principal amount of 200,000 yen can be received as the insurance money from the first nonlife insurance company 8a through the mutual aid institution 5 and it can be devoted to the repayment to the financial company 4.

Next, the case where Mr. B (the client 3) borrowed 300,000 yen from the financial company 4 by 15 installments of 20,000 yen monthly and died of injury two days after paying the mutual aid premiums will be explained as an example. Note that the limit amount is assumed to be 500,000 yen. In this case, the insurance by the first nonlife insurance company 8a without any exceptional period is applied to the bereaved of Mr. B, and the bereaved of Mr. B is able to receive 300,000 yen which is the remaining principal as the insurance money from the first nonlife insurance company 8a through the mutual aid institution 5 and able to devote it to the repayment to the financial company 4. Also, the bereaved of Mr. B can receive a balance of the limit amount and the remaining principal amount, 200,000 yen, as the solatium.

Next, the case where Mr. C (the client 3) borrowed 300,000 yen from the financial company 4 by 15 installments of 20,000 yen monthly and died of sickness 10 days after paying the mutual aid premiums will be explained as an example. Note that the limit amount is assumed to be 500,000 yen. In this case, the bereaved of Mr. C is applied the insurance by the life insurance company 9 without any exceptional period, able to receive the remaining principal of 300,000 yen from the life insurance company 9 as the insurance money through the mutual aid institution 5 and able to devote it to the repayment to the financial company 4. Also, the bereaved of Mr. C can receive a balance of the limit amount and the remaining principal amount, 200,000 yen, as the solatium.

Next, the case where Mr. D (the client 3) borrowed 300,000 yen from the financial company 4 by 15 installments of 20,000 yen monthly and got hospitalized for injury after finishing payments for 5 times will be explained as an example. In this case, Mr. D is applied the solatium by the second nonlife insurance company 8b without any exceptional period, able to receive the monthly repayment amount of 20,000 yen as the solatium so as to devote it to the repayment to the financial company 4.

The same effects as in the above second embodiment can be obtained and full security against voluntary bankruptcy can be obtained also by the insured warranty method using the system 2b according to the present embodiment as above.

Other Embodiments

Embodiments of the present invention were explained above, but the present invention is not limited by the embodiments and may be naturally embodied in various ways within the scope of the present invention.

For example, in the first and second embodiments, a guaranty institution (the guaranty company 6) and a nonlife insurance institution (the nonlife insurance company 8) are made up by separate institutions and the case where neither of the two have a subsidiary nor sub-subsidiary was explained as an example, but it may be configured that one or both of the guaranty institution and the nonlife insurance institution have a subsidiary and sub-subsidiary. Also, the guaranty institution and the nonlife insurance institution may be configured to be one institution.

Also, in the first and second embodiments, the case of unemployment security applied when a person having a regular job (a business person) loses the job was explained as an example. But it may be the case of income security applied when a person having a regular job or a workplace to go to gets hospitalized by sickness or injury and becomes unable to work. In this case, it is preferable that the first period is more than 7 days but not more than 372 days (12 months plus 7 days) after paying the insurance premiums or mutual aid premiums by the client, the exceptional period is preferably 7 days, and the upper limit of an amount to be paid by the nonlife insurance institution as insurance money is preferably an amount of 12 months of monthly repayments by the client to the financial institution.

Also, in the third embodiment, an insurance institution is made up by a plurality of nonlife insurance companies (the first nonlife insurance company 8a and the second nonlife insurance company 8b) and one life insurance company 9, but it may be made up only with a plurality of nonlife insurance companies and the mutual aid institution 5 may also serve as the life insurance company 9. Also, the respective nonlife insurance companies 8a and 8b may have a subsidiary nonlife insurance company and sub-subsidiary nonlife insurance company, etc., respectively.

What is claimed is:

1. An insured warranty system for performing processing by using a computer, wherein:
a part or all of insurance premiums paid to a guaranty institution by a client who got a loan from a financial institution is paid to a nonlife insurance institution by said guaranty institution as insurance money;
when said client becomes unable to work during a first period, a monthly repayment amount by the client to the financial institution during the period of being unable to work is paid by said nonlife insurance institution as insurance money in accordance with a period obtained by subtracting an exceptional period from the actual period of being unable to work; and
when said client are unable to work for more than upper limit months of said first period, said guaranty institution pays as guarantee a remaining repayment amount until the end of the period of being unable to work after exceeding the upper limit months of said first period, besides said payments by the nonlife insurance institution.

2. An insured warranty system for performing processing by using a computer, wherein:
a part or all of mutual aid premiums paid to a mutual aid institution by a client who got a loan from a financial institution is paid to a guaranty institution as guarantee and to a nonlife insurance institution as insurance money by said mutual aid institution;
when said client becomes unable to work during a first period, a monthly repayment amount by the client to the financial institution during the period of being unable to work is paid by said nonlife insurance institution as insurance money in accordance with a period obtained by subtracting an exceptional period from the actual period of being unable to work; and
when said client is unable to work for more than upper limit months of said first period, said guaranty institution pays as guarantee a remaining repayment amount until the end of the period of being unable to work after exceeding the upper limit months of said first period, besides said payments by the nonlife insurance institution.

3. The insured warranty system as set forth in claim 1 or 2, wherein said first period is more than one month and not more than seven months after a payment of guaranty premiums or mutual aid premiums is made by said client.

4. The insured warranty system as set forth in claim 3, wherein said exceptional period is one month.

5. The insured warranty system as set forth in claim 3, wherein an upper limit of an amount paid by said nonlife insurance institution as insurance money is an amount of six months of monthly repayments by the client to the financial institution.

6. The insured warranty system as set forth in claim 1 or 2, wherein said first period is more than 7 days and not more than 372 days (12 months plus 7 days) after a payment of guaranty premiums or mutual aid premiums is made by said client.

7. The insured warranty system as set forth in claim 6, wherein said exceptional period is seven days.

8. The insured warranty system as set forth in claim 6, wherein an upper limit of an amount paid by said nonlife insurance institution as insurance money is an amount of twelve months of monthly repayments by the client to the financial institution.

9. An insured warranty method for performing processing by using a computer, including:
the step that a part or all of insurance premiums paid to a guaranty institution by a client who got a loan from a financial institution is paid to a nonlife insurance institution by said guaranty institution as insurance money; and
the step that when said client becomes unable to work during a first period, a monthly repayment amount by the client to the financial institution during the period of being unable to work is paid by said nonlife insurance institution as insurance money in accordance with a period obtained by subtracting an exceptional period from the actual period of being unable to work; and when said client is unable to work for more than upper limit months of said first period, said guaranty institution pays as guarantee a remaining repayment amount until the end of the period of being unable to work after exceeding the upper limit months of said first period, besides said payments by the nonlife insurance institution.

10. An insured warranty method for performing processing by using a computer, including:
the step that a part or all of mutual aid premiums paid to a mutual aid institution by a client who got a loan from a financial institution is paid to a guaranty institution as guarantee and to a nonlife insurance institution as insurance money by said mutual aid institution; and
the step that when said client becomes unable to work during a first period, a monthly repayment amount by the client to the financial institution during the period of being unable to work is paid by said nonlife insurance institution as insurance money in accordance with a period obtained by subtracting an exceptional period from the actual period of being unable to work; and when said client is unable to work for more than upper limit months of said first period, said guaranty institution pays as guarantee a remaining repayment amount until the end of the period of being unable to work after exceeding the upper limit months of said first period, besides said payments by the nonlife insurance institution.

11. An insured warranty system for performing processing by using a computer, wherein:
a part or all of mutual aid premiums paid to a mutual aid institution by a client who got a loan from a financial institution is paid to an insurance institution by said mutual aid institution; and
during a first period, when said client
(i) goes into voluntary bankruptcy, a remaining principal amount by the client to the financial institution after that is paid by said insurance institution in a range of up to a limit amount set in advance;
(ii) dies, and when the limit amount is not more than a remaining principal amount as a result of comparing the remaining principal amount by the client to the financial institution with the limit amount set in advance, the limit amount is paid by said insurance institution, while when the limit amount exceeds the remaining principal amount, the limit amount and a balance obtained by subtracting the remaining principal amount from the limit amount are paid by said insurance institution; and
(iii) gets hospitalized or encounters a disaster on house, an amount of one month of monthly repayment by the client to the financial institution is paid by said insurance institution.

12. An insured warranty system for performing processing by using a computer, wherein:
a part or all of mutual aid premiums paid to a mutual aid institution by a client who got a loan from a financial institution is paid to two nonlife insurance institutions and one life insurance institution by said mutual aid institution; and
during a first period, when said client
(i) goes into voluntary bankruptcy, a remaining principal amount by the client to the financial institution after that is paid by one or both of said two nonlife insurance institutions in a range of up to a limit amount set in advance;
(ii-1) dies of injury, and when the limit amount is not more than a remaining principal amount as a result of comparing the remaining principal amount by the client to the financial institution with the limit amount set in advance, the limit amount is paid by one or both of said two nonlife insurance institutions, while when the limit amount exceeds the remaining principal amount, the limit amount and a balance obtained by subtracting the remaining principal amount from the limit amount are paid by one or both of said two nonlife insurance institutions;
(ii-2) dies of sickness, and when the limit amount is not more than a remaining principal amount as a result of comparing the remaining principal amount by the client to the financial institution with the limit amount set in advance, the limit amount is paid by said life insurance institutions, while when the limit amount exceeds the remaining principal amount, the limit amount and a balance obtained by subtracting the remaining principal amount from the limit amount are paid by said life insurance institutions; and
(iii) gets hospitalized or encounters a disaster on house, an amount of one month of monthly repayment by the client to the financial institution is paid by one or both of said two nonlife insurance institutions.

13. The insured warranty system as set froth in claim 11 or 12, wherein said first period is not more than twelve months after a payment of mutual aid premiums is made by said client.

14. The insured warranty system as set froth in claim 13, wherein an exceptional period is 45 days when said client goes into voluntary bankruptcy and zero when said client dies, get hospitalized or encounters disaster on house.

15. An insured warranty method for performing processing by using a computer, including:
the step that a part or all of mutual aid premiums paid to a mutual aid institution by a client who got a loan from a financial institution is paid to an insurance institution by said mutual aid institution; and
the step that, during a first period, when said client
(i) goes into voluntary bankruptcy, a remaining principal amount by the client to the financial institution after that is paid by said insurance institution in a range up to a limit amount set in advance;
(ii) dies, and when the limit amount is not more than a remaining principal amount as a result of comparing the remaining principal amount by the client to the financial institution with the limit amount set in advance, the limit amount is paid by said insurance institution, while when the limit amount exceeds the remaining principal amount, the limit amount and a balance obtained by subtracting the remaining principal amount from the limit amount are paid by said insurance institution; and
(iii) gets hospitalized or encounters a disaster on house, an amount of one month of monthly repayment by the client to the financial institution is paid by said insurance institution.

16. An insured warranty method for performing processing by using a computer, including:
the step that a part or all of mutual aid premiums paid to a mutual aid institution by a client who got a loan from a financial institution is paid to two nonlife insurance institutions and one life insurance institution by said mutual aid institution; and
the step that, during a first period, when said client
(i) goes into voluntary bankruptcy, a remaining principal amount by the client to the financial institution after that is paid by one or both of said two nonlife insurance institutions in a range of up to a limit amount set in advance;
(ii-1) die of injury, and when the limit amount is not more than a remaining principal amount as a result of comparing the remaining principal amount by the client to the financial institution with the limit amount set in advance, the limit amount is paid by said one or both of said two nonlife insurance institutions, while when the limit amount exceeds the remaining principal amount, the limit amount and a balance obtained by subtracting the remaining principal amount from the limit amount are paid by one or both of said two nonlife insurance institutions;
(ii-2) die of sickness, and when the limit amount is not more than a remaining principal amount as a result of comparing the remaining principal amount by the client to the financial institution with the limit amount set in advance, the limit amount is paid by said life insurance institutions, while when the limit amount exceeds the remaining principal amount, the limit amount and a balance obtained by subtracting the remaining principal amount from the limit amount are paid by said life insurance institutions; and
(iii) gets hospitalized or encounters a disaster on house, an amount of one month of monthly repayment by the client to the financial institution is paid by said one or both of said two nonlife insurance institutions.
